(19) United States
(12) Patent Application Publication
(10) Pub. No.: US 2024/0003858 A1
(43) Pub. Date: Jan. 4, 2024

(54) SYSTEMS AND METHODS FOR THE PURIFICATION OF RADIOPHARMACEUTICALS USING THIN LAYER CHROMATOGRAPHY (TLC) PLATES

(71) Applicant: THE REGENTS OF THE UNIVERSITY OF CALIFORNIA, Oakland, CA (US)

(72) Inventors: Michael R. Van Dam, Los Angeles, CA (US); Travis S. Holloway, Los Angeles, CA (US); Alejandra Rios, Los Angeles, CA (US); Chelsea Okoro, Los Angeles, CA (US)

(73) Assignee: THE REGENTS OF THE UNIVERSITY OF CALIFORNIA, Oakland, CA (US)

(21) Appl. No.: 18/250,911

(22) PCT Filed: Oct. 29, 2021
(86) PCT No.: PCT/US2021/057394

§ 371 Date: Apr. 27, 2023

Related U.S. Application Data
(60) Provisional application No. 63/110,964, filed on Nov. 6, 2020.

(51) Int. Cl. G01N 30/95; B01J 20/28; B01J 20/34; B01D 15/42

(52) U.S. Cl. CPC G01N 30/95; B01J 20/28035; B01J 20/3475; B01D 15/426; B01J 2220/52; B01J 2220/49

(57) ABSTRACT

A method of purifying radiochemical species (e.g., radiopharmaceuticals) using thin layer chromatography (TLC) plates includes loading one or more TLC plates with a sample containing the radiochemical species to be purified. The one or more TLC plates are then developed with a mobile phase. The one or more developed TLC plates are then imaged to obtain radioactivity image(s) of the one or more TLC plates. Optional UV images may also be obtained using the same imaging platform. The location of the radiochemical species on the one or more TLC plates is identified from the radioactivity image(s). The radiochemical species on the one or more TLC plates is/are removed at the identified locations. Removal may be accomplished using a mechanical process such as scraping or punching. Alternatively, non-destructive techniques may be employed to remove the radiochemical species from the TLC plate(s).

### RELATED APPLICATION

This application claims priority to U.S. Provisional Patent Application No. 63/110,964 filed on Nov. 6, 2020, which is hereby incorporated by reference. Priority is claimed pursuant to 35 U.S.C. § 119 and any other applicable statute.

### STATEMENT REGARDING FEDERALLY SPONSORED RESEARCH AND DEVELOPMENT

This invention was made with government support under Grant Number EB024243, awarded by the National Institutes of Health. The government has certain rights in the invention.

### TECHNICAL FIELD

The technical field relates to the use of radio-thin layer chromatography (radio-TLC) for the purification of radiopharmaceuticals. More specifically, the technical field relates to the use of TLC plates for the purification or optional formulation (for injection) of radiopharmaceuticals.

### BACKGROUND

Positron emission tomography (PET) is a non-invasive biological imaging tool used to measure specific biological processes in vivo, quantitatively, and with exceptional sensitivity. It is an invaluable tool for research, drug development, and clinical care. Unfortunately, the complexity and high cost of producing the needed short-lived radiolabeled PET tracers limits the ability for investigators to obtain and use these tracers, or to further develop new tracers and imaging protocols into reliable quantitative biological assays.

In recent years, new methods of PET tracer manufacture, especially microfluidics, are opening the possibility of vastly reduced tracer production cost and complexity, through reduced consumption of expensive reagents, efficient production of preclinical batches (providing high molar activity while avoiding the unnecessary use of high activity levels), and compact instrumentation that can be self-shielded, thereby reducing necessary infrastructure. This has been accomplished by significant miniaturization of many steps in the synthesis of tracers including radioisotope separation and concentration, multi-step synthesis, and formulation. However, the purification step has largely been left unaddressed. Recent work in microscale radiochemistry has gravitated to purification using high-performance liquid chromatography (HPLC) with analytical-scale columns. While an improvement over conventionally used semi-preparative columns, the high cost and large size of the HPLC instrument undermines the benefits of microscale radiosynthesis. There have been a few reports of microscale removal of impurities via miniaturized scavenging methods and solid-phase extraction with miniature cartridges, but these methods left impurities in the final product and cannot easily be adapted to new tracers. The resolution of solid phase extraction (SPE)-based methods may be inadequate for separation of complex mixtures, especially, as is the case in radiochemistry, when the desired product (PET tracer) and impurities (precursor and precursor by-products) are chemically very similar. In order to provide improved separation resolution and versatility, full chromatographic separation methods seem to be necessary.

### SUMMARY

In one embodiment, one or more TLC plates are used to purify radiopharmaceuticals. The methods and systems may also be used to formulate radiopharmaceuticals for injection. Radiolabeled (F-18) PET tracers (or other radiopharmaceuticals) are loaded onto the TLC plate(s) and then exposed to an appropriate mobile phase for separation. Next, the TLC plate(s) are then subject to an optional radioactivity imaging operation that includes Cerenkov luminescence imaging (CLI) or scintillation-based imaging for the readout of TLC plate(s) to highlight radiolabeled species. CLI exhibits very high imaging resolution enabling multiple species to be baseline separated including minor impurities that are undetectable using conventional TLC readout methods (e.g., scanning detector). The imaging operation may also optionally include ultraviolet imaging of the TLC plate(s) to highlight the non-radioactive species, and white light to visualize origin and solvent front markings. The UV and CLI images may be merged to create a 2D chromatogram or image.

After imaging, the stationary phase of the TLC plate(s) at the position of the desired product(s) is/are removed. Removal may be accomplished using a scraping process whereby a working tool that includes a blade or the like along with a vacuum is used to remove the sorbent material/particles that contain the desired radiochemical species. A punch tool may also be used. The sorbent material/particles may then be exposed to a solution for product extraction followed by filtration using a filter. Removal may alternatively be accomplished using an automated process. For example, a facing microfluidic chip or the like may be used to flush out species directly from the TLC plate(s). As another option, one or more barriers may be printed, created, or affixed on the TLC plate(s) around the desired radiochemical species and then another mobile phase is introduced to offload the desired radiochemical species from the TLC plate(s). Optionally, the product may be formulated, for example, by dilution with an acceptable dilutant (e.g., saline).

It has been shown that under optimized TLC mobile phase conditions (e.g., developed through PRISMA optimization), that a variety of F-18 radiolabeled analogues can be rapidly purified (e.g., [¹⁸F]Fallypride, [¹⁸F]PBR-06, and [¹⁸F]FET) from non-radioactive (UV) and radioactive contaminants. The purified compound can be collected from the TLC plate by manual scraping of the stationary phase using a scraper and vacuum manifold, then extracted from the TLC sorbent material/particles with biocompatible extractant solution that is rapidly formulated for direct injection into patients. To confirm the purification effectiveness, the purified/formulated sample was subjected to typical analytical HPLC analysis, and exhibited high radiochemical and chemical purity, showing the potential to rival conventional purification procedures with HPLC but in a fraction of the time, and with a significantly smaller and lower-cost apparatus.

Notably, TLC offers the potential to streamline conventional reformulation procedures necessary for injection. HPLC often utilizes toxic organic additives (e.g., methanol, acetonitrile, or chromatographic additives like trimethylamine, trifluoroacetic acid, or acetic acid) that are water soluble and require lengthy downstream solvent exchange processes. In TLC, organic phases used to purify the target product are evaporated rapidly from the plate due to the small quantities and high surface area. Downstream, the collected product can be stripped from the sorbent phase with a bolus of ethanol, that can be formulated for injection with the addition of saline (e.g., nine parts saline to ensure a final ethanol content <10% v/v), overcoming an existing issue with the use of HPLC for PET tracer purification.

Considering that TLC plates, unlike HPLC columns, do not need to be equilibrated with mobile phase prior to use, TLC purification is a highly accelerated method for PET tracer purification, if producing multiple PET tracers sequentially. HPLC systems have a single pump that only allow one tracer to be purified at a time. Instead, multiple TLC chambers (for multiple TLC plates) could be used to purify multiple tracers at a time. In this regard, TLC could be used to purify several tracers in parallel. With the advent of high-throughput radiosynthesis methods and PET scanners that can image multiple animals at a time, TLC may be an efficient and cost-effective means to maximize use of these high-throughput synthesizers and/or scanners.

The TLC-based purification method and platform described herein may be suited for purifying microfluidically-produced radiopharmaceuticals (e.g., PET tracers). This microscale purification platform would allow radiotracer production to be fully implemented in a compact microfluidic platform. Such technology could have a profound impact on the manufacturing and delivery of radiotracers, including substantial cost reductions, that could open up access to novel and established tracers in a myriad of research applications.

In one embodiment, a method of purifying radiochemical species using thin layer chromatography (TLC) plates includes loading one or more TLC plates with a sample containing the radiochemical species to be purified; developing the one or more TLC plates with a mobile phase; optionally imaging the one or more TLC plates to obtain Cerenkov image(s) or scintillation-based image(s) of the one or more TLC plates; identifying the location of the radiochemical species on the one or more TLC plates from the Cerenkov or scintillation-based image(s); and removing the radiochemical species on the one or more TLC plates at the identified locations. In an alternative embodiment the one or more TLC plates are illuminated with UV light to obtain images of the positions of the non-radioactive species on the one or more TLC plates where are used in conjunction with the Cerenkov or scintillation-based image(s) to identify the location of the radiochemical species of interest relative to radioactive and non-radioactive impurity species. In some embodiments, no imaging is used as the location of the product band is known in advance (e.g., through experimentation). In this embodiment, imaging may be skipped and the radiochemical species on the one or more TLC plates are removed at the identified locations.

In another embodiment, a method of purifying radiochemical species using thin layer chromatography (TLC) plates includes: loading one or more TLC plates with a sample containing the radiochemical species to be purified; developing the one or more TLC plates with a mobile phase; and removing the radiochemical species on the one or more TLC plates at pre-determined locations on the one or more TLC plates. These pre-determined locations may be specific distances located from the edge(s) of the TLC plate. The specific distances may be determined empirically.

In another embodiment, a device for purifying radiochemical species using thin layer chromatography (TLC) plates includes a working instrument comprising a blade or sharp edge and a vacuum tube or conduit having an inlet disposed adjacent to the blade or sharp edge and operatively coupled to a source of vacuum. The device includes a collection tube for collecting sorbent material and/or particles from the TLC plate(s) and includes a filter or frit contained therein. A sterilizing filter is fluidically coupled to an outlet of the collection tube. A product vessel is fluidically coupled to an output side of the filter.

The device for purifying radiochemical species using TLC plates may be integrated in an automated system. For example, spotting or loading of the sample(s) onto the TLC plates can be performed using an automated loading device (e.g., non-contact dispensers or the like). Developing of the TLC plates may also be accomplished in an automated fashion including the optional imaging operation. Extraction then proceeds using the scraping operation as described herein (manual or automated). Alternatively, extraction may proceed by flowing an extraction fluid across the surface of the TLC plate (e.g., using a microfluidic chip or flow cell).

In another embodiment, an automated device for purifying radiochemical species using a thin layer chromatography (TLC) plate includes a reservoir configured to hold a mobile phase. A support is disposed above the reservoir and configured to hold the TLC plate thereon. The device includes a wick having a first end positioned within the reservoir and a second end in detachable contact with the TLC plate. A moveable flow cell is provided in the device that is coupled to an eluent source and having an outlet, the moveable flow cell configured to move along a length of the TLC plate and selectively contact the TLC plate at different positions, wherein eluent flowing through the moveable flow cell elutes radiochemical species from the TLC plate to the outlet. The automated device may also have an automated sample dispenser disposed above the TLC plate and configured to deposit a volume of sample onto the TLC plate. Optional heaters can be located in the support. A sensor may also be located in the support to detect the presence of the advancing front of the mobile phase in the TLC plate.

### BRIEF DESCRIPTION OF THE DRAWINGS

FIG. 1 schematically illustrates the operations or steps for TLC purification (and formulation) of radiopharmaceuticals (e.g., radiotracers) according to one embodiment.

FIG. 2A illustrates a cross-sectional view of a TLC plate.

FIG. 2B illustrates a cross-sectional view of a TLC plate after a sample containing radiochemical species has been deposited onto the TLC plate and developed. The spot containing the radiochemical species within the sorbent material is illustrated.

FIG. 2C schematically illustrates the removal of the sorbent material of FIG. 2B. The radiochemical species and sorbent material (e.g., particles) are removed using a mechanical operation.

FIG. 2D illustrates a pre-concentration TLC plate with a concentration zone or region and a development zone or region. Also illustrated is a large sample spot that forms a thinner band at the interface between the concentration zone and development zone which then undergoes further separation in the development zone. Arrow A illustrates the direction of fluid flow.

FIG. 3A illustrates a radiation imaging platform augmented with UV and brightfield imaging.

FIG. 3B illustrates hypothetical images from activation of white light only (showing origin and solvent front in brightfield image), UV light only (showing non-radioactive impurities), and no lights or Cerenkov luminescence (showing radioactive species).

FIG. 3C illustrates a radiation imaging platform according to another embodiment.

FIG. 4A illustrates a hypothetical image of a developed TLC plate with CLI and UV readouts superimposed. The product (P) and impurity (X) are illustrated at different distances from the origin line on the TLC plate.

FIG. 4B illustrates the signal intensity as a function of distance along the dashed line of FIG. 4A, used to compute separation resolution between the product (P) and adjacent impurity (X) to aid in optimization of the separation conditions.

FIG. 5 illustrates a TLC plate with a plurality of lanes formed thereon. Barriers formed on the TLC plate define the different lanes. Sample locations for each lane are shown along with the direction of travel (arrow A) in response to exposure to the mobile phases.

FIG. 6A illustrates an embodiment for removing radiochemical species from a TLC plate using a microfluidic chip. A microfluidic chip is brought into contact with a developed TLC plate. Radiochemical species are transferred from the TLC plate to the microfluidic chip through fluid that is passed through the microfluidic chip and exposed to region(s) of the TLC plate.

FIG. 6B illustrates one embodiment of the microfluidic chip of FIG. 6A illustrating how various open regions located along a portion of the microfluidic chip can be actuated to elute specific bands of interest of a TLC plate that is placed in contact with the microfluidic chip.

FIG. 7A illustrates images (Cerenkov, UV, and overlay) of TLC purification of [¹⁸F] PBR-06. The product collected overlay image is also shown, composed from images taken after product harvesting from the TLC plate.

FIG. 7B illustrates the analytical HPLC trace of the collected product. The top shows the UV absorbance channel while the bottom shows radioactivity channel.

FIG. 8A illustrates images (Cerenkov, UV, and overlay) of TLC purification of [¹⁸F]Fallypride. The product collected overlay image is also shown, composed from images taken after product harvesting from the TLC plate.

FIG. 8B illustrates the analytical HPLC trace of the collected product. The top shows the UV absorbance channel while the bottom shows radioactivity channel.

FIG. 9A illustrates a product collection system according to one embodiment. This embodiment uses a working instrument that is used to scrape sorbent material/particles from the TLC plate. An integrated vacuum conduit or tube that is coupled to a source of vacuum is used to collect this scraped material which is collected in a tube (SPE tube adapter). The collection tube is coupled to a filter which is used to perform sterile filtration of the collected product. The desired radiopharmaceutical product passes through the filter and enters a sterile collection vial. This can be diluted with, for example, saline for formulation. The formulated radiotracer can then be administered to the subject after passing relevant quality tests.

FIG. 9B illustrates an alternative embodiment of a product collection system. The system is the same as that illustrated in FIG. 9A with the addition of an optional waste collection system that allows washing of residual solvents or other impurities off of the collected TLC material/particles prior to eluting off the desired product.

FIG. 10A illustrates a side view of an automated TLC system according to one embodiment. The TLC plate is located on a support disposed above a reservoir that contains the mobile phase. A wick provides a flow path from the reservoir to the TLC plate and is detachable from the TLC plate. A moveable flow cell is used to contact the TLC plate after development to elute one or more bands from the TLC plate. Eluent flows through a moveable head and contacts a specific slice or region of the TLC plate to elute the radiochemical species from the TLC plate. The automated TLC system may also include an automated sample dispenser that deposits known volumes of sample onto the TLC plate.

FIG. 10B illustrates a top-down view of the moveable flow cell, TLC plate, and wick.

### DETAILED DESCRIPTION OF ILLUSTRATED EMBODIMENTS

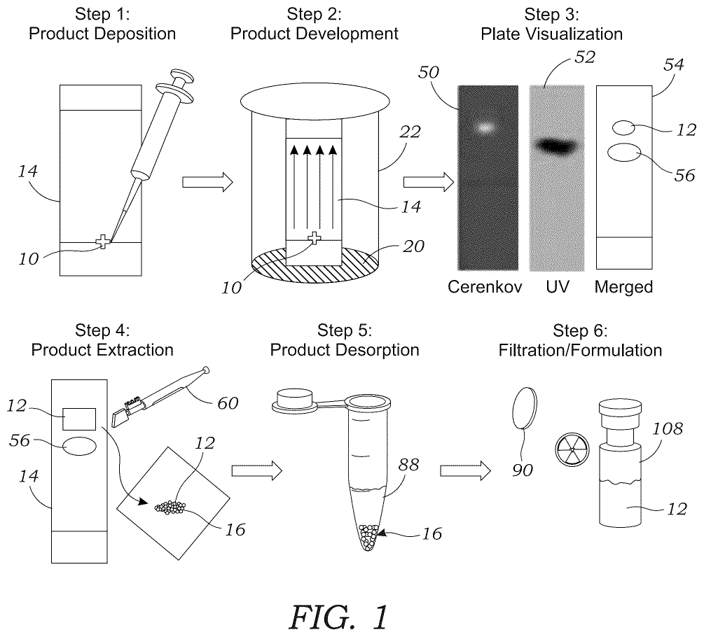

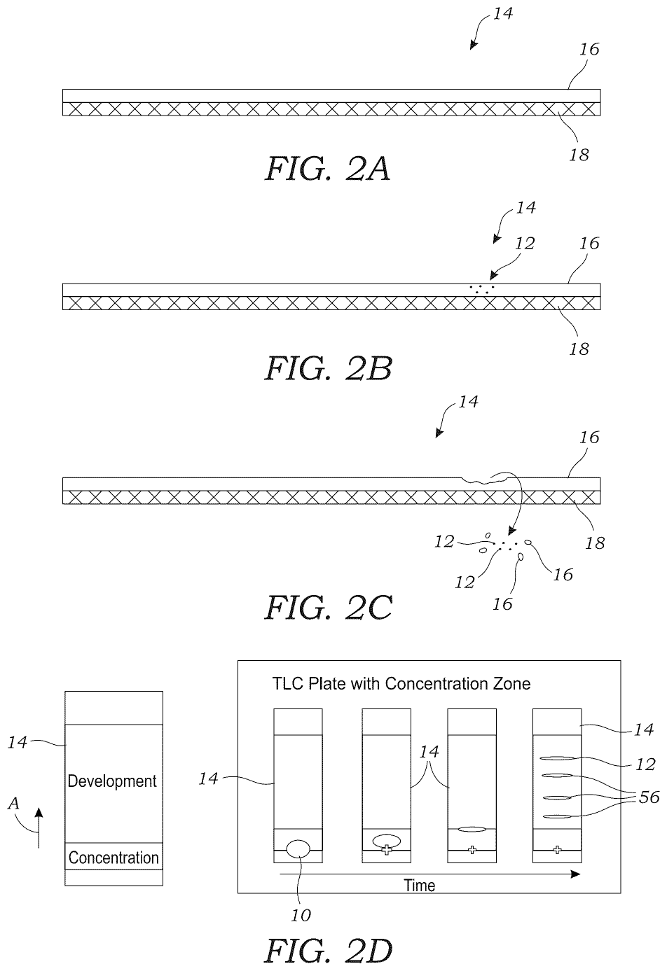

FIG. 1 schematically illustrates an illustrative workflow sequence for the TLC purification (and optional formulation operation) of radiopharmaceuticals (e.g., radiotracers). In the first step (step 1), the sample 10 containing the radiochemical species 12 to be purified is deposited on the TLC plate(s) 14. Prior to use, the TLC plate(s) 14 may be subject to a cleaning operation that includes ascending development with polar solvent mixtures to transport plate-derived impurities out of the section of development prior to sample loading. The TLC plates 14 include a sorbent material 16 on a backing or substrate 18 as seen in FIGS. 2A-2C. TLC 14 plates may be commercially purchased. TLC plates 14 have a backing material 18 that is typically aluminum, glass, or a polymer or plastic material. Sorbent materials 16 vary but include, for example, silica, alumina, cellulose, bonded phases, polyamide, and the like. TLC plates 14 may incorporate a fluorescent indicator (e.g., willemite, Zn₂SiO₄) in the sorbent material to aid in UV imaging. In addition, fluorescent or other visual indicators may be added to the TLC plates 14 (e.g., by spraying or the like). TLC plates 14 without any visualization indicator may also be used. Some compounds naturally fluoresce when exposed to short or long UV wavelengths so an indicator may not be needed to visualize non-radioactive species. TLC plates 14 are available in a variety of sizes and thicknesses. The thickness determines how much sample mass/volume can be separated. For radiopharmaceutical applications, analytical thicknesses are used which is around 250 μm although other thickness may be used (e.g., 100 μm TLC plates that are commercially available).

TLC plates 14 that may be used in connection with the invention described herein can include pre-concentration TLC plates 14 such as that illustrated in FIG. 2D that have a zone of highly porous sorbent material 16 (Concentration zone) abutted against a region of more tightly packed sorbent material 16 (Development zone). The concentration zone has a highly porous structure with low internal surface area and weak sorption. These TLC plates 14 provide a way to handle large sample volumes. Large sample volume generally will lead to a very large spot of sample 10. The pre-concentration zone of these TLC plates 14 will essentially ‘focus’ the spot to a thin but wide line at the interface of the two zones (as seen in right-side of FIG. 2D), and then that thin line will undergo separation in the second zone with much better resolution than if the initial sample was not focused in this manner.

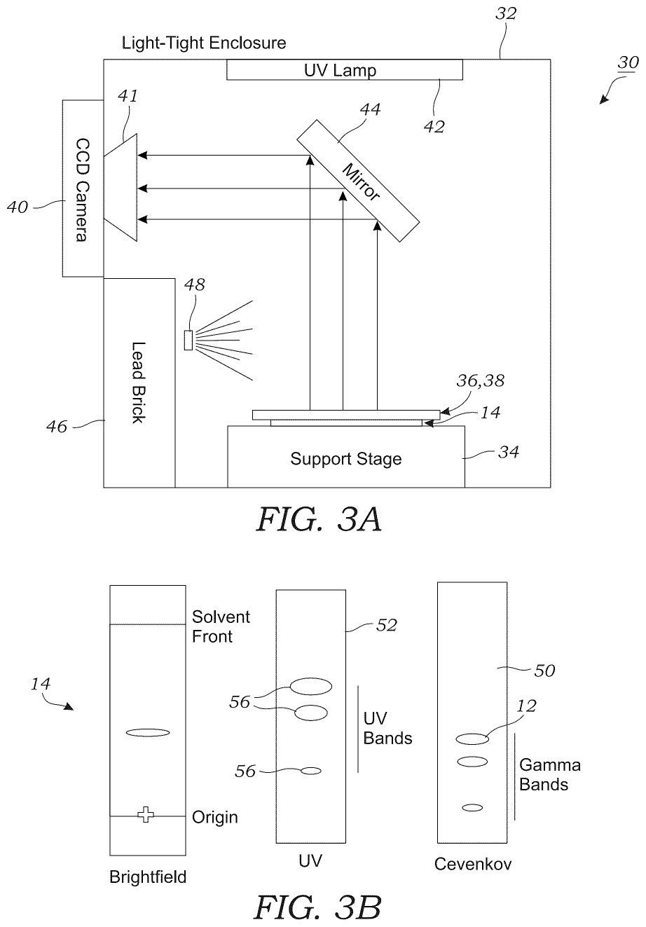

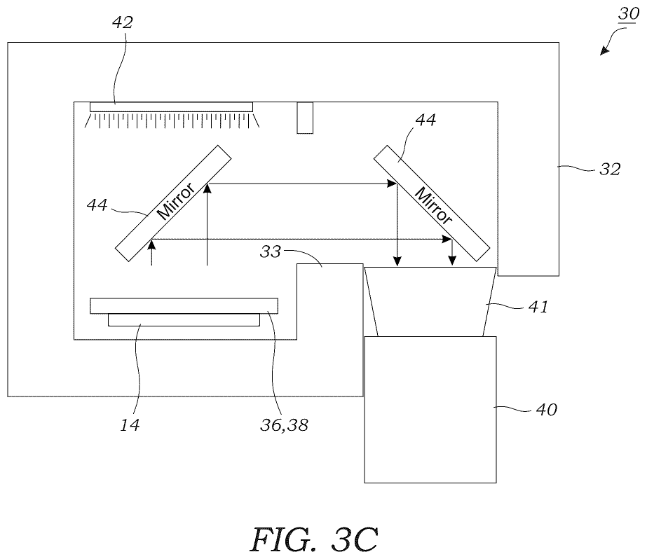

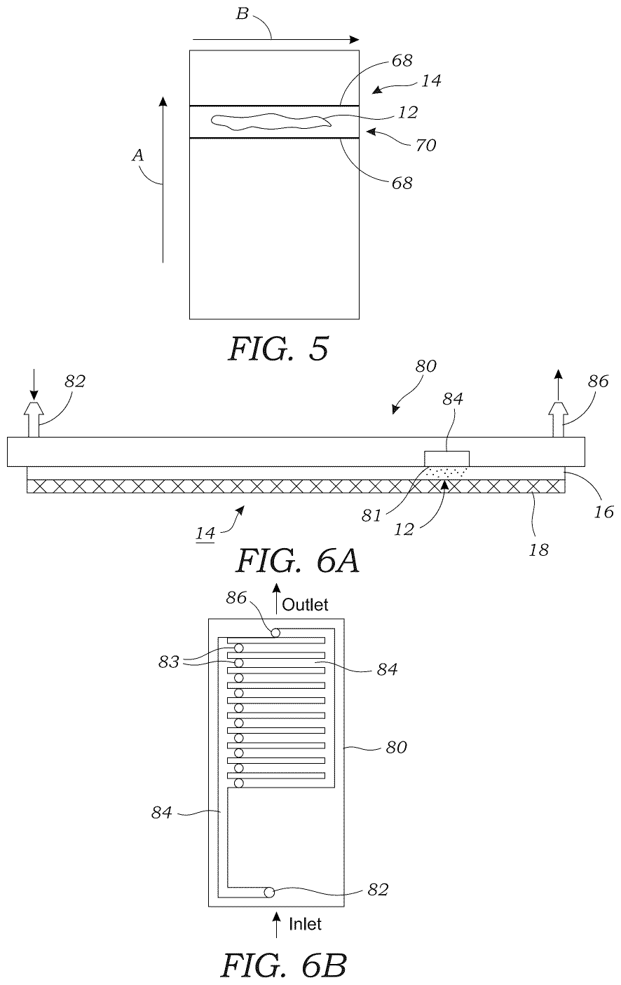

The sample 10 may be spotted on the TLC plate 14 as one or more spots or a streak or line. The amount of sample 10 that is loaded on the TLC plate(s) 14 is typically in the tens of microliters (e.g., 60-80 μL) and may vary. The sample 10 may be loaded in portions, each time allowing the previously loaded portion to dry before loading a next portion. A single TLC plate 14 may have a single spot of the sample 10 or multiple spots of the sample(s) 10 may be loaded into separate “lanes” on the TLC plate 14 (e.g., FIG. 5). The sample(s) 10 may be loaded manually using a pipette or the like or may be loaded automatically using, for example, a non-contact dispenser. Next, the TLC plate(s) 14 are developed by exposing the end of the TLC plate(s) 14 to a mobile phase 20. This is illustrated in step 2 of FIG. 1. A container 22 is provided that contains the mobile phase 20. For multiple TLC plates 14, different containers 22 with different mobile phases 20 may be used to run development in parallel. Examples of mobile phases 20 that may be used include pure solvents or mixtures of solvents, including ethanol, methanol, acetonitrile, ethyl acetate, hexanes, toluene, dimethyl sulfoxide (DMSO), and dichloromethane (DCM). TLC mobile phase conditions may be developed through a variety of approaches including PRISMA optimization. PRISMA is a known technique used for systematic optimization of mobile phase compositions. Generally, the first step involves using the Snyder selectivity triangle to determine three effective solvents for analyte separation based on analyte intermolecular forces. The second step explores different mixtures of these effective solvents and often another additive to control solvent strength to find the best separation of analytes. Here, and separate from the conventional PRISMA optimization, a final step creates a representation of separation resolution as a function of mobile phase composition and solvent strength. Interpolation is done between data points to compute the best solvent mobile phase for product separation. The TLC plates 14 may be developed over several minutes or more. The amount of time depends on the type of mobile phase 20 that is used. The TLC plates 14 may be optionally dried either through drying in ambient conditions or with aid of applied heat. Once the TLC plate(s) 14 is/are developed, the TLC plate(s) 14, in some embodiments, is/are subject to visualization (step 3 of FIG. 1) using an imaging platform 30 like that illustrated in FIG. 3A.

With reference to FIG. 3A, the imaging platform 30 includes a light-tight enclosure 32 that contains a support stage 34 that holds the TLC plate(s) 14. A glass slide 36 is disposed atop the TLC plate(s) 14. Alternatively, a sheet of organic or inorganic scintillator 38 is place atop the TLC plate 14 to provide an amplified signal via scintillation (i.e., scintillation-based imaging). For radioactivity imaging (both Cerenkov imaging and scintillation-based imaging), a camera 40 (e.g., sensitive charge coupled device (CCD) camera or complementary metal-oxide semiconductor (CMOS)) with lens 41 is used to detect Cerenkov light emission or scintillation light as positrons travel through the transparent cover on the TLC plate(s) 14. Typically, the image sensor in the camera 40 is cooled to reduce noise. For example, the camera 40 may include a scientific cooled camera (QSI 540, Quantum Scientific Imaging, Poplarville, MS) equipped with a 50 mm lens (Nikkor, Nikon, Tokyo, Japan). The temperature of the camera 40 was maintained at −10° C. for dark current reduction. This same camera 40 is used (when applicable) to capture UV images of the TLC plate(s) 14 using a UV lamp 42 that is located in the light-tight enclosure 32 to determine the location of non-radioactive species on the TLC plate(s). As seen in FIG. 3A, a folded optical path is formed with a mirror 44 between the TLC plate(s) 14 and the camera 40. A lead brick 46 is also located in the light-tight enclosure 32 or housing so as to reduce noise by decreasing the number of gamma rays that interacted directly with the CCD image sensor of the camera 40 leading to noise that does not originate from Cerenkov luminescence or scintillation from the cover over the TLC plate(s) 14. In some embodiments, a separate white light source 48 is located in the light-tight enclosure 32 to obtain brightfield images to show the position of the sample origin(s), solvent front line, and product 12 locations (if using visible stains to highlight functional groups of species on the TLC plate(s) 14). However, in many cases, the origin, solvent front, and product 12 locations can all be found in the UV image 52. FIG. 3B illustrates an exemplary brightfield image (left), UV image 52 (center), and Cerenkov luminescence image 50 (right).

FIG. 3C illustrates an alternative embodiment of an imaging platform 30. In this embodiment, the imaging platform 30 is made even more compact while avoid to shield the highly-sensitive cooled CCD camera 40 and associated optics (e.g., lenses). This embodiment uses a shielded light-tight enclosure 30 with an intervening shielded region 33 that is interposed between the camera 40 and the TLC plate 14. A folded optical path with mirrors 44 or other high-efficiency optics are used to guide light emitted from the TLC plate 14 to the lens 41 and camera 40, which is located external to the shielded light-tight enclosure 30. This geometry ensures adequate radiation shielding in all directions, but requires much less total shielding than if the camera 40 and lens 41 were enclosed.

Staining of TLC plates 14 may be performed for quality control/assurance purposes. Such stains may be used during purification to help increase the visibility of other radioactive or non-radioactive impurities. Staining may be accomplished by dipping the developed TLC plate 14 into a suitable stain. Exemplary stains include, for example, p-anisaldehyde, vanillin, Ninhydrin, Hanessian, Dragendorffs Reagent, and Iodine as examples. The TLC plate 14 is removed from the stain and excess stain may be removed using an absorbent material placed into contact with the stained TLC plate 14. Optionally, some stains may require heating to visualize compounds of interest. Other stains, however, may be visualized at room temperature. The stained TLC plates 14 may be imaged with an imager device (e.g., brightfield imaging device as described herein). Ninhydrin, for example, may be used to highlight species containing primary amines or amino acids. Hanessian TLC staining reveals the presence of oxidizable species.

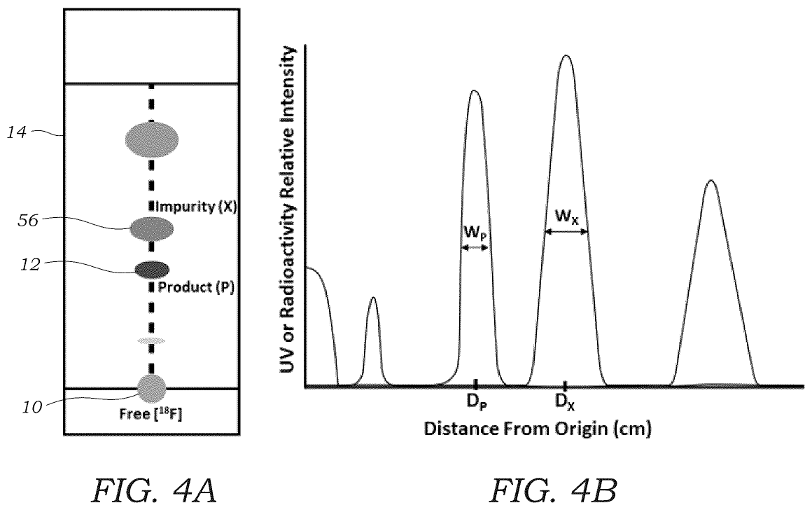

Returning to FIG. 1, Step 3 illustrates TLC plate 14 visualization. Here, a radioactivity image 50 (here Cerenkov luminescence image) is shown along with a UV image 52. A merged image 54 is generated by image processing software that merges the radioactivity image 50 and the UV image 52 into a single merged image 54. The merged image 54 thus shows the radioactive species 12 (captured in the Cerenkov image) as well as the non-radioactive impurity 56 (captured in the UV image). At that point, the actual physical location(s) of the radioactive species 12 (i.e., desired product(s)) on the TLC plate(s) 14 is known. FIG. 4B, for example, illustrates how signal intensity as a function of distance along the TLC plate 14 (dashed line) may be used to compute separation resolution between the radioactive species 12 (i.e., product (P) in FIG. 4A) and adjacent impurity 56 (X in FIG. 4A) (and physical location on TLC plate 14 of product (P)).

In some embodiments, the operation of TLC plate 14 visualization is not needed. For example, empirical results may demonstrate that the radiochemical species 12 moves a certain distance or within a range of distances for a particular type of TLC plate 14 and plate development process. These are pre-determined location(s) where the desired radiochemical species 12 is located. Experimental results may show that the desired radiochemical species 12 may be found within a certain distance from the origin of the sample 10 on the TLC plate 14. In this case, visualization is not needed and the region of the TLC plate 14 that lies at or within the distance range may be removed as disclosed herein.

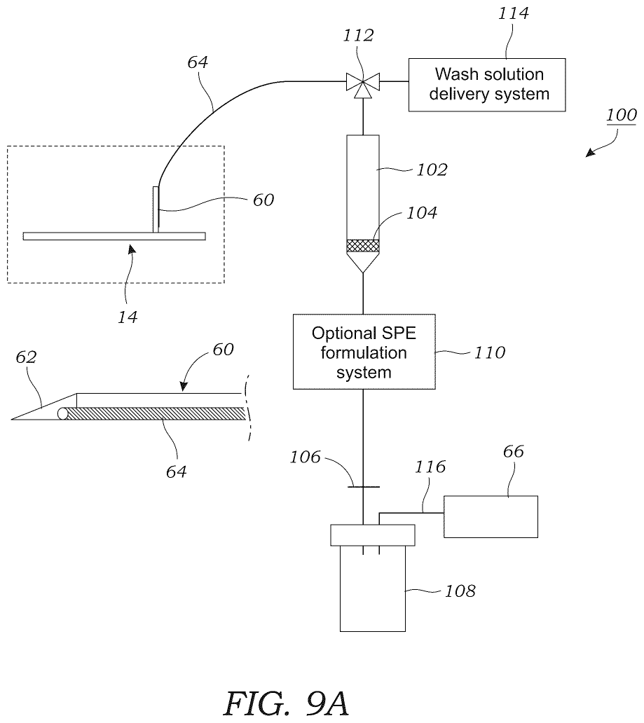

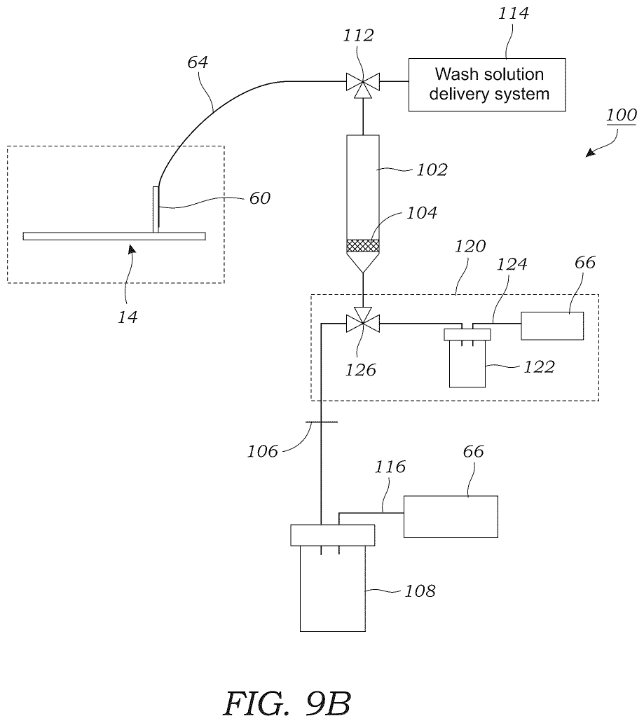

With the knowledge of the location of the radiochemical species 12 known (either through visualization or experimentation), the desired product or radioactive species 12 is then removed from the TLC plate(s) 14. FIG. 1 illustrates a product extraction operation (Step 4) where a working instrument 60 is used to physically scrape sorbent material 16 (e.g., sorbent particles) with the desired product or radioactive species 12 from the TLC plate(s) 14. The working instrument 60 may include a hand-held tool with a blade 62 (see FIG. 9A) for scraping and a vacuum tube 64 that is coupled to a source of vacuum 66 to vacuum the removed sorbent material 16. The desired product or radioactive species 12 is located in the sorbent material 16 as seen in FIG. 2B. The working instrument 60 may then be manually manipulated by a user to remove the small region of the TLC plate 14 such as that illustrated in FIG. 2C containing the desired product. Product extraction may also take place using an automated operation. For example, a robotically manipulated working instrument 60 may be able to remove the desired product or radioactive species 12 from the TLC plate(s) 14. As an alternative to just removing the sorbent material 16 from the TLC plate(s) 14, the target band or location can be extracted by punching out the portion of the TLC plate 14 containing the product band. The punched-out region of the TLC plate 14 may include, for example, a circular-shaped punch or a rectangular-shaped punch. In such a case, the working instrument is a punch.

Alternatively, barriers 68 are formed on the TLC plate 14 after development. The barriers 68, which are formed from a liquid-impermeable material such as wax or waxy-like substance, are formed on the TLC plate 14 on either side of the band or region that contains the radiochemical species 12 of interest. The barriers 68 form a lane 70 that is generally perpendicular to the direction of solvent travel (arrow A). The radiochemical species 12 of interest can then be removed from the TLC plate 14 by flowing liquid in the direction of lane (i.e., in the direction of arrow B (or reverse direction) and generally perpendicular to the direction of solvent travel (arrow A)). An eluent may be placed in contact with the side of the TLC plate 14 and the desired radiochemical species 12 are collected at the opposing side (eluent+radiochemical species 12).

In yet another alternative, and with reference to FIGS. 6A and 6B, a microfluidic chip 80 or the like may abut or make contact with the TLC plate 14 on the side with the sorbent material 16 and provide selectable flow paths that can be used to isolate and extract radioactive species 12 (or other desired products) from the TLC plates 14. The microfluidic chip 80, for example, which may be elastomeric, is be brought into contact with the TLC plate 14 after plate development. Flowing an extractant solution 88 through the microfluidic chip 80 (e.g., a bolus of fluid) may also be used to remove the product band as an alternative to scraping or punching. With reference to FIGS. 6A and 6B, fluid enters the microfluidic chip 80 via the inlet 82 and enters one or more channels 84 that come into contact with the sorbent material 16 at discrete locations along the microfluidic chip 80. For example, open regions 81 in the microfluidic chip 80 along the one or more channels 84 (e.g., an open surface of the lateral channels 84) may provide fluid access to the sorbent material 16 of the TLC plate 14 at different locations. These open regions 81 may contain sealing surfaces (e.g., on their periphery) so that fluid does not leak out between the TLC plate 14 and the microfluidic chip 80. Fluid comes into contact with the desired product or radioactive species 12 from the TLC plate 14 and is then transported back into the microfluidic chip 80 and out the outlet 86. Fluid may be targeted to a desired open region 81 of interest located along the microfluidic chip 80 by using valves 83 to direct fluid into the appropriate flow paths. For example, elastomeric valves 83 powered pneumatically may be used to shunt fluid into the desired channel passageway 84 to the desired open region 81. For wide bands, multiple open regions 81 may be used to elute the radiochemical species 12.

Referring back to FIG. 1 and the operations utilized in the method, Step 5 illustrates product desorption whereby an extractant solution 88 is used to remove the radioactive species 12 or desired product from the sorbent material 16. An example of such an extractant solution 88 includes a biocompatible buffer (e.g., saline), mixtures of ethanol and buffer, mixtures containing any of the synthesis reactant solvents, mixtures of polar solvents. Other solvents include, but are not limited to, methanol, acetonitrile, dimethyl sulfoxide (DMSO), and dichloromethane (DCM). The extractant 88 may be optionally heated and/or mixed to aid in recovery.

As explained herein, the sorbent material 16 may be separated from the sorbent-exposed extractant 88 solution in a filtration step. Step 6 of FIG. 1 illustrates a filtration/formulation operation being performed. Here, the sorbent-exposed extractant 88 is run through a filter 90 (or frit 104 and/or sterile filter 106 as explained herein) which leads to a product vessel 108 (e.g., sterile vial) and an optional dilutant is added. For example, a vacuum 66 may be used to pull the sorbent-exposed extractant solution 88 through a filter 90 whereby the sorbent material 16 remains on the filter 90 while the radiochemical species 12 or product enters the product vessel 108. For formulation, a dilutant is added to the filtrate to dilute the same. This may include, for example, saline. For example, saline may be added to bring the final ethanol content to below 10% v/v. For many radiopharmaceuticals saline or saline/ethanol mixtures have proven effective for extraction from the sorbent. This overcomes existing problems with HPLC which uses toxic organic solvents that requires a separate downstream formulation step. It should be appreciated that other ingredients may be included in the final product. This includes additives to inhibit radiolysis (e.g., ascorbate buffer), additives to improve solubility (e.g., polyethylene glycol), or buffers to allow for pH adjustment.

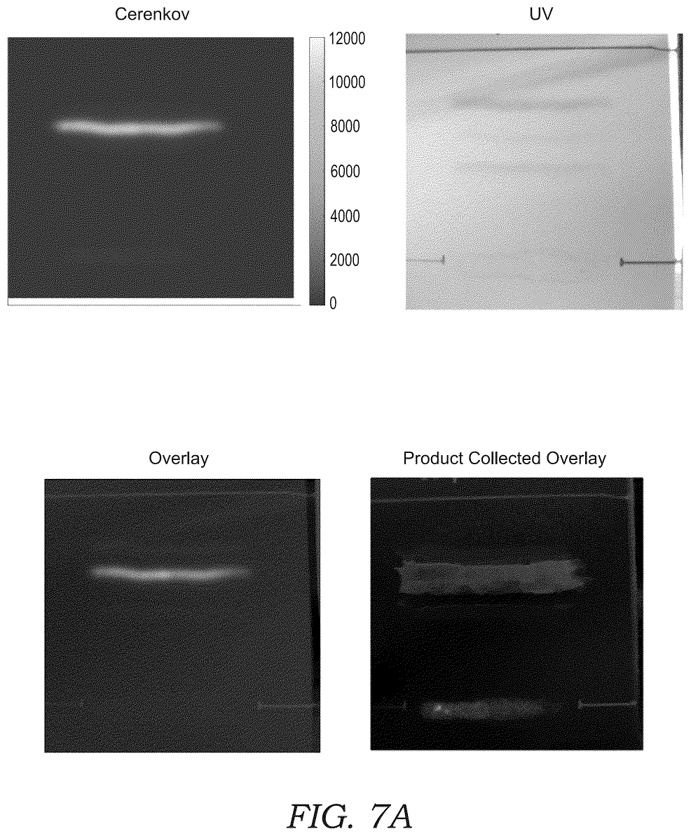

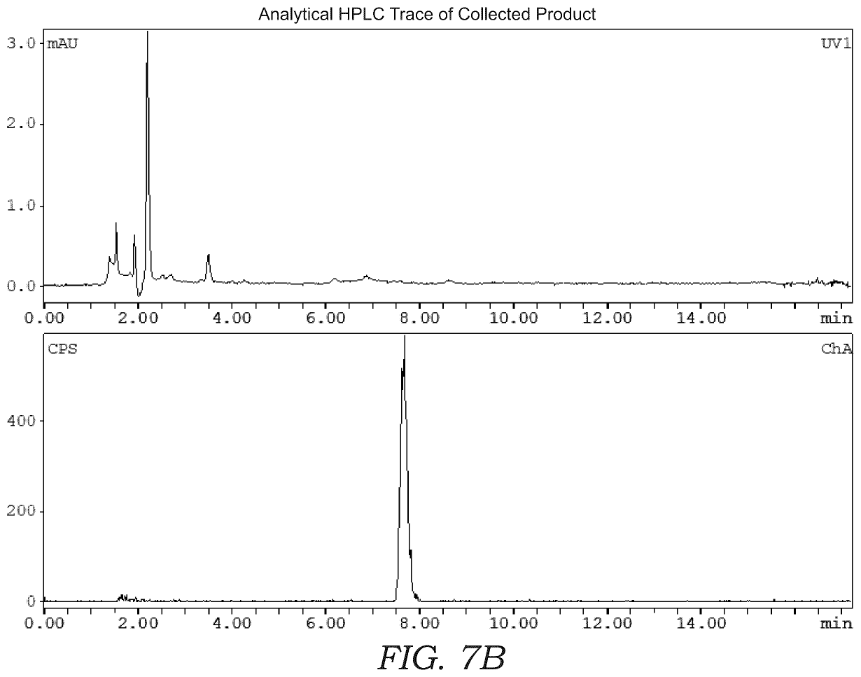

FIG. 7A illustrates images of a TLC plate 14 (Cerenkov, UV, and merged—top row) of the TLC purification of [¹⁸F] PBR-06. The product collected overlay image is also shown (bottom row). The latter is an image of the TLC plate 14 after the scraping/extraction of the desired product band containing the radiochemical species 12 has been performed. The Cerenkov product band is “missing” from this composite image. Of course, the inventive method disclosed herein does not require that this composite image after product harvesting be performed, although it could be used for quality control purposes. FIG. 7B shows the analytical HPLC trace of the collected product showing a pure radiochemical species 12 is obtained within very minor radio-impurities (bottom chromatogram), and only very minor non-radioactive impurities (top chromatogram).

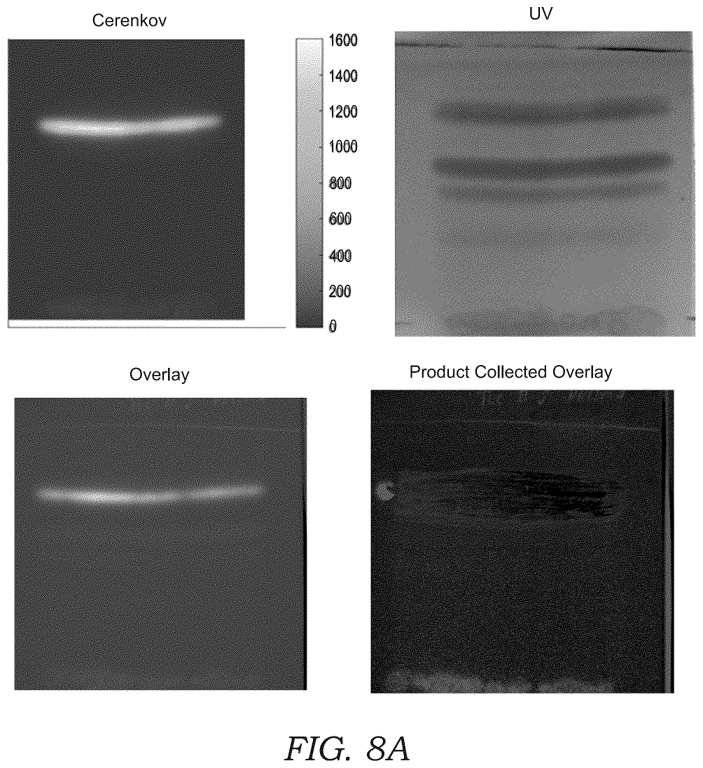

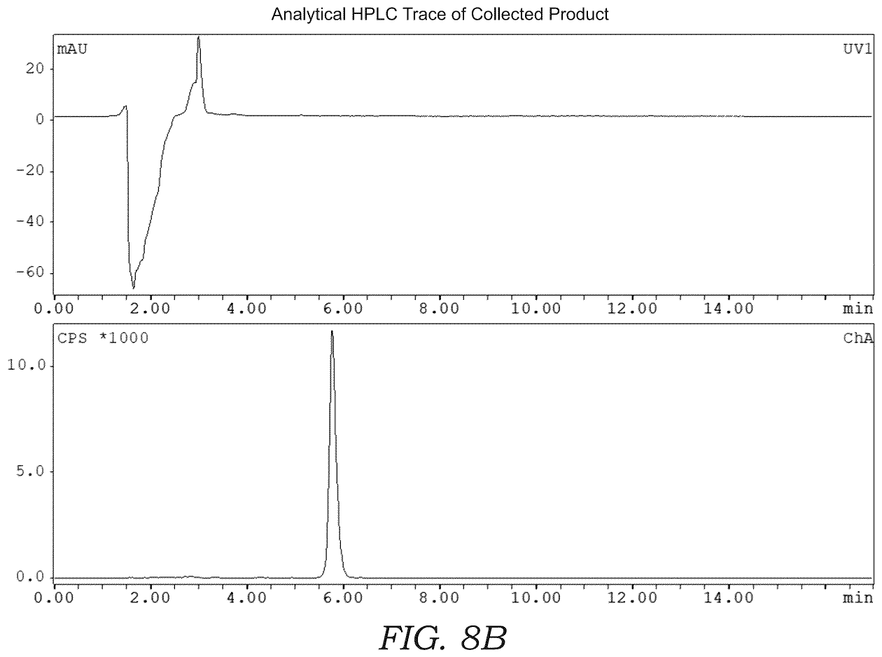

FIG. 8A illustrates images of a TLC plate 14 (Cerenkov, UV, and merged) of TLC purification of [¹⁸F]Fallypride similar to those of FIGS. 7A and 7B. The product collected overlay image is also shown after product band harvesting (with missing Cerenkov product). FIG. 8B shows the analytical HPLC trace of the collected product again showing minor radio-impurities (bottom chromatogram), and minor non-radioactive impurities (top chromatogram).

Table 1 below shows the activity level (MBq) (both high and low levels), Extraction Efficiency (%), and Formulation Efficiency (%) of the TLC purification performance of several batches of two model radiochemical species 12: [¹⁸F]Fallypride and [¹⁸F]PBR06. Formulation efficiency is with saline (0.9% NaCl). Here, TLC plates 14 were spotted with crude reaction mixtures, allowed to dry, then developed with a mobile phase The developed TLC plates 14 were each allowed to dry and then imaged to determine the location of the desired product band on each TLC plate 14. The sorbent in the product band region was scraped from the TLC plate 14, and, with the aid of vacuum, was collected into a solid phase extraction tube with frit. The collected sorbent material was exposed to saline (500 uL) and the extracted radiopharmaceutical product 12 in saline was then collected into a sterile vial 108 by application of vacuum. No dilution was required. Note that the batches with higher activity levels are sufficient for multiple clinical dose amounts of the radiopharmaceutical.

TABLE 1

| | Activity | Extraction | Formulation |
|---|---|---|---|
| | Level | Efficiency | Efficiency |
| Tracer | (MBq) | (%) | (%) |
| [¹⁸F]Fallypride | 7.5 | (n = 3) | (n = 3) |
| | | 96.1 ± 0.5 | 98 ± 0.6 |
| | 740-1480 | (n = 2) | (n = 2) |
| | | 95.8 ± 0.3 | 98 ± 0.4 |
| [¹⁸F]PBR06 | 11 | (n = 3) | (n = 3) |
| | | 93.3 ± 1.6 | 95 ± 2.1 |
| | 1110-1480 | (n = 2) | (n = 2) |
| | | 96.7 ± 0.4 | 96 ± 1.4 |

FIG. 9A illustrates one embodiment of a product collection system 100 according to one embodiment. This embodiment uses a working instrument 60 that is used to scrape or extract sorbent material 16 from the TLC plate(s) 14. The working instrument 60 is manually manipulated or automatically operated through a robotic arm or the like and includes a blade or sharp edge 62 that is used to manually scrape sorbent material 16 from the TLC plate(s) 14. The working instrument 60 has a tube or conduit 64 with an open end or inlet adjacent to the blade or sharp edge 62 that is coupled to a source of vacuum 66 (e.g., a vacuum source that is applied to the sterile vial pulls vacuum through the device). The vacuum within the tube or conduit 64 is able to vacuum the sorbent material 16 from the TLC plate(s) 14 (e.g., as seen in FIG. 2C) and deposit the sorbent material 16 that contains the radiochemical species 12 in a collection device 102 or directly onto a filter such as frit 104. As seen in FIG. 9A, the collection device 102 is a tube (e.g., SPE tube) that contains a frit 104. The collection tube 102 is coupled to a sterile filter 106 (e.g., polyvinylidene fluoride filter (PVDF)) which is used to perform sterile filtration of the collected product. The desired radiopharmaceutical species 12 (i.e., product) passes through the filter 106 and enters a sterile product vessel 108 (e.g., vial). This can be diluted with, for example, saline for formulation into a form suitable for administration of the radiopharmaceutical species 12 to a subject. FIG. 9A further shows an optional SPE formulation system 110 that is interposed between the collection tube 102 and the sterile filter 106 (e.g., 0.2 μm filter). This optional system 110 allows formulation of the radiopharmaceutical 12 (e.g., tracer) in the event that saline and/or ethanol is not sufficient to wash the product off the TLC plate 14 and a more toxic solvent is needed. The SPE formulation system 110 includes a SPE cartridge and valves/conduits that flow various agents therethrough. For example, the extractant solution 88 would be run through the SPE cartridge, which would trap the desired radiopharmaceutical while the liquid was collected in a waste container. The cartridge would then be rinsed to remove residual solvents into the waste container. Finally, an eluent agent such as ethanol is then flowed through the SPE cartridge of the SPE formulation system 110 to release the desired product from the cartridge through the filter 106 to the product vessel 108.

As seen in FIG. 9A a valve 112 is interposed prior to the collection device 102. This valve 112 enables flow to proceed from the working instrument 60 or from a wash solution delivery system 114. The wash solution delivery system 114 provides the first extraction solution (e.g., ethanol), wash/rinse solutions, and/or formulation medium. Alternatively, the extraction solution (e.g., ethanol) may be pulled through the same conduit tubing 64 from the working instrument 60. This may be accomplished by inserting the inlet of the vacuum tubing or conduit into a container holding the extraction solution. As an alternative the valve, a Y-junction may be used and the entire system being vacuum driven. Note that solutions may be vacuum driven or, in some alternatives, pushed through with the aid of pressure (e.g., nitrogen) (e.g., wash, rinse, formulation solutions).

As seen in FIG. 9A, the product vessel 108 such as a sterile vial capped with a septum has a vacuum hose 116 connected to a source of vacuum 66 (e.g., house vacuum). A micron filter may be interposed between the source of vacuum 66 and the product vessel 108. If liquids are pushed with positive pressure (e.g., nitrogen), there is a vent (not shown) out of the sterile vial 108 that is capped with a similar filter. Vacuum thus pulls the extractant solution 88 containing the radiochemical species 12 (or other solutions such as formulation medium) through the filter 106 and into the product vessel 108 (or positive pressure pushes the radiochemical species 12). Extraction solution 88 may also be pulled using this same vacuum hose 116 as explained herein to contact with the sorbent material 16 in the SPE tube 102. The product vessel 108 may be pre-loaded with sterile formulation medium (e.g., saline). Additionally, or alternatively, compressed nitrogen may be used to deliver saline to the product vessel 108 to dilute the concentration of the extraction solvent. Saline may also be added manually to the product vessel 108 using aseptic procedures. For example, the extraction solvent may include ethanol which is reduced to a low, regulatory-compliant concentration prior to administration to the subject by the addition of saline. The sterile formulation medium may also contain buffers or other stabilizers known to those skilled in the art.

FIG. 9B illustrates an alternative embodiment of a product collection system 100. The system 100 is the same as that illustrated in FIG. 9A with the addition of an optional waste collection system 120 that allows washing of impurities off of the collected sorbent material 16 from the TLC plate 14 prior to eluting off the desired product. The system 120 includes a waste container 122 that is used to hold waste. Tubing 124 connects to a source of vacuum 66 which is used to pull waste fluid into the waste container 122. A valve 126 is provided that can direct fluid either to the waste collection system 120 or to the sterile filter 106 and product vessel 108.

While FIGS. 9A and 9B illustrate a mechanical extraction method, other methods of extraction may be used to collect the desired radiochemical species 12 and formulation in the product vessel 108. This includes, for example, flowing liquid across the TLC plate(s) 14 in the desired region(s). This could be done using a barrier 68 such as a waxy substance that is used to define lanes 70 to remove the product from the TLC plate(s) 14 such as that illustrated in FIG. 5. A bolus of fluid can be added to extract a particular product band or region from the TLC plate 14 including, for example, using a microfluidic device 80 that contacts or abuts the TLC plate 14 and defines a flow path to extract the product on the TLC plate (e.g., the embodiment of FIG. 6). In these embodiments, the microfluidic device 80 may take the place of the working instrument 60 of FIGS. 9A and 9B.

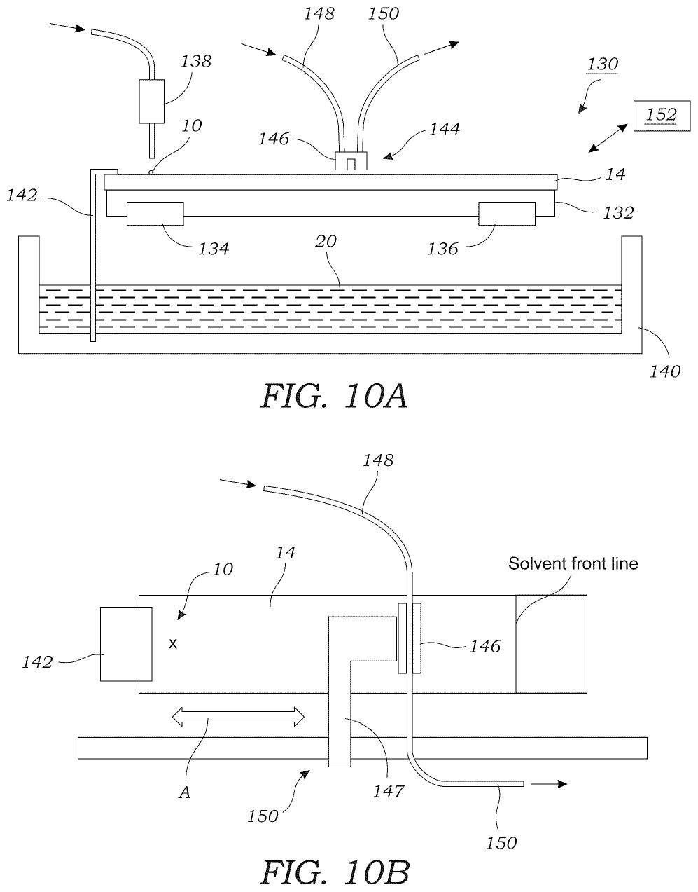

FIGS. 10A and 10B illustrate an embodiment of an automated TLC system 130 according to one embodiment. The automated TLC system 130 is able to perform spotting on the TLC plate(s) 14, development of the TLC plate(s) 14, and product collection from the TLC plate(s) 14. With reference to FIG. 10A, the TLC plate 14 is located atop a support 132 that is oriented in a horizontal plane. The support 132 may have integrated therein one or more optional heater elements 134 to heat the TLC plate 14 and accelerate drying of the spotted sample 10 on the TLC plate 14. In addition, in some embodiments, a liquid sensor 136 is integrated into the support 132. The liquid sensor 136 may be a thermal, capacitive, or resistive sensor that is positioned along the length of the support 132 to detect the arrival of the solvent front of the mobile phase 20 used during TLC plate development.

A sample dispenser 138 is located above the support 132 and TLC plate 14 and is used to deposit volume(s) of sample 10 onto the TLC plate 14. The sample dispenser 138 may be stationary or, in other embodiments, could be robotically controlled using an x, y gantry for example. The sample dispenser 138 is coupled to the sample source which may include, for example, a microdroplet synthesizer that is used to generate the radiochemical species 12. A reservoir 140 is provided that contains the mobile phase 20 used in TLC plate development. A wick 142 is provided that contacts the mobile phase 20 and selectively forms a fluid path from the reservoir 140 to the TLC plate 14. For example, the opposite end of the wick 142 (not in the mobile phase 20) can be selectively moved into contact with the TLC plate 14 by, for example, use of an actuator. When the wick 142 is in contact with the TLC plate 14, the mobile phase 20 is able to travel through the wick 142 and onto the TLC plate 14. Once the liquid sensor 136 detects the presence of the arrival of the front of the mobile phase 20, the wick 142 may be moved out of contact with the TLC plate 14 (e.g., with actuator). As an alternative to a moveable wick 142, the mobile phase 20 could be evacuated from the reservoir 140 (e.g., using a pump or gravity flow) to stop the separation process. The pump (not shown) may also be used to fill the reservoir 140 with mobile phase 20 in addition to removing the same. Additional heater elements 134 may be used to aid in this drying process.

After the TLC plate 14 has been developed, the TLC plate 14 then undergoes imaging using an imaging platform 130 as described herein. The automated TLC system 130 may be located inside of, or partly inside of, the imaging platform 130 in some embodiments as part of an overall integrated system. After undergoing CLI and/or UV imaging, a flow cell device 144 is used to extract product bands located on the developed TLC plate 14. The particular locations of the desired product band with the desired radiochemical species 12 is determined based on the imaging process. Alternatively, if the desired radiochemical species 12 is known to travel a certain distance along the TLC plate 14, the flow cell device 144 can be located at or moved to this location for product removal. The flow cell device 144 includes a moveable head 146 has an opening or aperture shaped in a thin or elongate shape that generally matches the thin geometry of the expected bands on the developed TLC plate 14. The moveable head 146 is mounted to an actuator 147 (e.g., robotic arm, gantry, belt) that can be positioned at different positions on the TLC plate 14. FIG. 10B illustrates how the actuator 147 moves the moveable head 146 in the direction of arrow A. Once in the desired location, the moveable head 146 contacts the TLC plate 14 (e.g., clamps on the TLC plate 14) and forms a seal with the TLC plate 14. Eluent fluid is then flowed into the moveable head 146 via an inlet tube 148 where it contacts the band of interest containing the radiochemical species 12 and elutes the same into the fluid which is removed from the moveable head 146 using outlet tube 150. A control system 152 may be provided to control the various operations of the automated TLC system 130 (including the imaging platform 30. The control system 152 coordinates the sample dispenser 138, actuation of the wick 142, heater(s) 134, liquid sensor 136, and readout from data and/or images generated from the imaging platform 30. As an alternative to the flow cell device 144 with the moveable head 146, a microfluidic chip 80 like that illustrated in FIGS. 6A and 6B may be used to exposed the band of interest containing the radiochemical species 12 to elute the same into eluent fluid that is flowed through the microfluidic chip 80. The control system 152 may also control the actuation of the valves 83 of the embodiment illustrated in FIGS. 6A and 6B to control which lateral channel(s) 84 or opening(s) are open to extractant flow.

While embodiments of the present invention have been shown and described, various modifications may be made without departing from the scope of the present invention. The methods and platforms are generally applicable to not only PET tracers (labeled with fluorine-18 or other isotopes) but other radiochemicals including SPECT tracers, and theranostic/radiotherapeutic compounds (e.g., compounds labelled with beta- and alpha-emitters). Exemplary PET tracers include, for example, [¹⁸F]Fallypride, [¹⁸F]FLT, and [¹⁸F]FMZ. In addition, other detection methods may be used in conjunction with, or as an alternative to, CLI or scintillation-based imaging. This may include high-resolution linear scanning using a narrow collimator or a multi-element radiation detector (e.g., solid-state detector). In such embodiments, the band of interest may be detected at a specific location of the TLC plate 14 using a detector without imaging per se. The invention, therefore, should not be limited, except to the following claims, and their equivalents.

1. A method of purifying radiochemical species using thin layer chromatography (TLC) plates comprising:
loading one or more TLC plates with a sample containing the radiochemical species to be purified;
developing the one or more TLC plates with a mobile phase;
imaging the one or more TLC plates to obtain Cerenkov image(s) or scintillation-based image(s) of the one or more TLC plates;
identifying the location of the radiochemical species on the one or more TLC plates from the Cerenkov or scintillation-based image(s); and
removing the radiochemical species on the one or more TLC plates at the identified locations.

2. The method of claim 1, wherein the removing operation comprises physically removing sorbent material from the one or more TLC plates at the identified locations.

3. The method of claim 2, wherein the sorbent material is removed by scraping or punching.

4. (canceled)

5. The method of claim 1, wherein the radiochemical species are removed from the one or more TLC plates without physically removing sorbent material from the one or more TLC plates.

6. The method of claim 5, wherein the radiochemical species is removed by placing a microfluidic chip in contact with the one or more TLC plates and flowing an eluent through the microfluidic chip along one or more valved open channels oriented generally perpendicular to a direction of solvent flow in the one or more TLC plates to contact a region of the one or more TLC plates containing the radiochemical species.

7. The method of claim 5, wherein the radiochemical species is removed by placing a flow cell device in contact with the one or more TLC plates and flowing an eluent through the flow cell device to contact a region of the one or more TLC plates containing the radiochemical species.

8. The method of claim 2, further comprising exposing the sorbent material to an extractant and filtering the sorbent exposed extractant to remove the sorbent material from the extractant.

9. The method of claim 8, further comprising diluting the filtered sorbent exposed extractant with a dilutant.

10. The method of claim 8, wherein the extractant comprises one or more of saline, ethanol, methanol, acetonitrile, dimethyl sulfoxide (DMSO), ethyl acetate, hexanes, toluene and dichloromethane (DCM), or mixtures thereof.

11. The method of claim 2, further comprising filtering the removed radiochemical species to filter out sorbent material from the one or more TLC plates.

12. The method of claim 1, further comprising imaging the one or more TLC plates to obtain UV image(s) of the one or more TLC plates.

13. The method of claim 12, further comprising generating a merged image of the one or more TLC plates with the Cerenkov or scintillation-based image(s) and the UV image(s).

14. The method of claim 1, wherein a plurality of TLC plates are loaded with sample(s) containing the radiochemical species to be purified.

15. The method of claim 1, wherein the one or more TLC plates comprise a fluorescent indicator.

16. The method of claim 1, wherein the one or more TLC plates have a thickness within the range of about 100 μm to about 250 μm.

17. The method of claim 1, wherein the one or more TLC plates comprise pre-concentration TLC plates.

18. A method of purifying radiochemical species using thin layer chromatography (TLC) plates comprising:
loading one or more TLC plates with a sample containing the radiochemical species to be purified;
developing the one or more TLC plates with a mobile phase; and
removing the radiochemical species on the one or more TLC plates at pre-determined locations on the one or more TLC plates.

19. The method of claim 18, wherein the removing operation comprises physically removing sorbent material from the one or more TLC plates at the identified locations.

20. The method of claim 19, wherein the sorbent material is removed by scraping or punching.

21. (canceled)

22. The method of claim 19, wherein the radiochemical species are removed from the one or more TLC plates without physically removing sorbent material from the one or more TLC plates.

23. The method of any of claims 19-21, further comprising exposing the sorbent material to an extractant and filtering to remove the sorbent material from the sorbent exposed extractant.

24. The method of claim 23, wherein the extractant comprises one or more of saline, ethanol, methanol, acetonitrile, dimethyl sulfoxide (DMSO), ethyl acetate, hexanes, toluene and dichloromethane (DCM), or mixtures thereof.

25. The method of claim 18, further comprising filtering the removed radiochemical species.

26-41. (canceled)
